(19) United States
(12) Patent Application Publication
(10) Pub. No.: US 2014/0069885 A1
(43) Pub. Date: Mar. 13, 2014

(54) Infant Cup With Rotating Straw

(71) Applicant: Mattel, Inc., El Segundo, CA (US)

(72) Inventors: Ryan Paxson, East Aurora, NY (US); Charlie Smith, East Amherst, NY (US); Domenic T. Gubitosi, East Aurora, NY (US)

(21) Appl. No.: 14/021,281

(22) Filed: Sep. 9, 2013

Related U.S. Application Data
(60) Provisional application No. 61/700,017, filed on Sep. 12, 2012.

(51) Int. Cl. A47G 19/22; A61J 9/00

(52) U.S. Cl. CPC A47G 19/2272; A61J 9/006
USPC 215/11.4; 220/709; 220/710.5; 215/11.5

(57) ABSTRACT

An infant cup includes a container, a lid, and an elbow straw. The container is configured to receive and hold a fluid and contains an opening at the top of the container. Furthermore, the lid is sealingly engaged with the container and includes an outlet configured to output the contents of the container. Moreover, the elbow straw is rotatably coupled to the lid and configured to sit and rotate within the container when the lid is coupled to the container. Additionally, the straw is weighted and thus, no matter what direction a child tips the infant cup, the tip of the straw will always rotate to be in contact with the fluid within the container. The elbow straw is also removable from the lid for ease of cleaning. The container may also contain handles attached to the outside of the container.

### CROSS REFERENCE TO RELATED APPLICATION AND CLAIM TO PRIORITY

This application claims priority under 35 U.S.C. 119(e) to U.S. Provisional Patent Application Ser. No. 61/700,017, entitled “Infant Cup with Rotating Straw”, filed Sep. 12, 2012, the disclosure of which is incorporated herein by reference in its entirety for all purposes.

### FIELD OF THE INVENTION

The present invention relates to an infant beverage container. More specifically, the present invention is an infant beverage container that includes a straw attached to the lid and which rotates within the container.

### BACKGROUND OF THE INVENTION

Various types of beverage containers exist for infants. Because infants are in the early stages of development, they generally do not understand spatial concepts such as up and down, right and left, etc. Therefore, when an infant attempts to drink out of an infant beverage container, the infant may hold the beverage container the wrong way. This may cause fluid to flow too quickly out of the outlet. Moreover, no liquid at all my flow out of the beverage container if the beverage container is held and used in an improper manner. Furthermore, with certain sippy cups, the design of the lid and spout cause fluid to undesirably remain within the container. These cups always leave part of the fluid within the container, causing waste of a product or leaving infants unsatisfied and wanting more.

Therefore, what is needed is an infant beverage container that is designed to allow the same amount of fluid flow from within the container despite the manner in which the beverage container is used or held. Furthermore, what is needed is a beverage container that contains an inner straw that rotates within the container, enabling fluid to be extracted from the container at any angle the beverage container may be held. What is needed is an infant beverage container that makes it easier for children who are still developing cognitive and motor skills to be able to drink without the help of their parents.

### SUMMARY OF THE INVENTION

According to one exemplary embodiment, an infant cup according to the present invention includes a container, a lid removably coupled to the base, and a straw rotatably coupled to the lid. The container contains an opening which is covered when the lid is attached to the container. Furthermore, the lid includes an exterior, an interior, and an outlet disposed on the exterior of the lid. In addition, the straw is rotatably coupled to the interior of the lid, where the straw is configured to rotate within the container when the lid is attached to the container. Moreover, the straw is in fluid communication with the outlet of the lid.

### BRIEF DESCRIPTION OF THE DRAWINGS

FIG. 1 illustrates a cross sectional view of an exemplary embodiment of an infant cup according to the present invention.

FIG. 2 illustrates a perspective view of the second embodiment of an infant cup according to the present invention.

FIG. 3 illustrates a cross-sectional view of the infant cup of FIG. 2.

FIG. 4 illustrates a perspective view of the container and the handle attachment of the infant cup of FIG. 2.

FIG. 5 illustrates a top perspective view of the lid of the infant cup of FIG. 2.

FIG. 5a illustrates a bottom perspective view of the lid of the infant cup of FIG. 2.

FIG. 6 illustrates a top perspective view of the insert of the infant cup of FIG. 2.

FIG. 6a illustrates a bottom perspective view of the insert of the infant cup of FIG. 2.

FIG. 6b illustrates a side view of the insert of the infant cup of FIG. 2.

FIG. 7a illustrates a top perspective view of the insert coupled to the lid of the infant cup of FIG. 2.

FIG. 7b illustrates a bottom perspective view of the insert coupled to the lid of the infant cup of FIG. 2.

FIG. 8 illustrates a perspective view of the insert elbow straw of the infant cup of FIG. 2.

FIG. 9 illustrates a perspective view of the attachment collar of the infant cup of FIG. 2.

FIG. 10 illustrates a perspective view of the insert elbow straw of FIG. 8 coupled to the attachment collar of FIG. 9.

FIG. 11 illustrates a bottom perspective view of the lid with the insert coupled to the lid, the attachment collar coupled to the insert, and the elbow straw coupled to the attachment collar of the infant cup of FIG. 2.

Like reference numerals have been used to identify like elements throughout this disclosure.

### DETAILED DESCRIPTION OF THE INVENTION

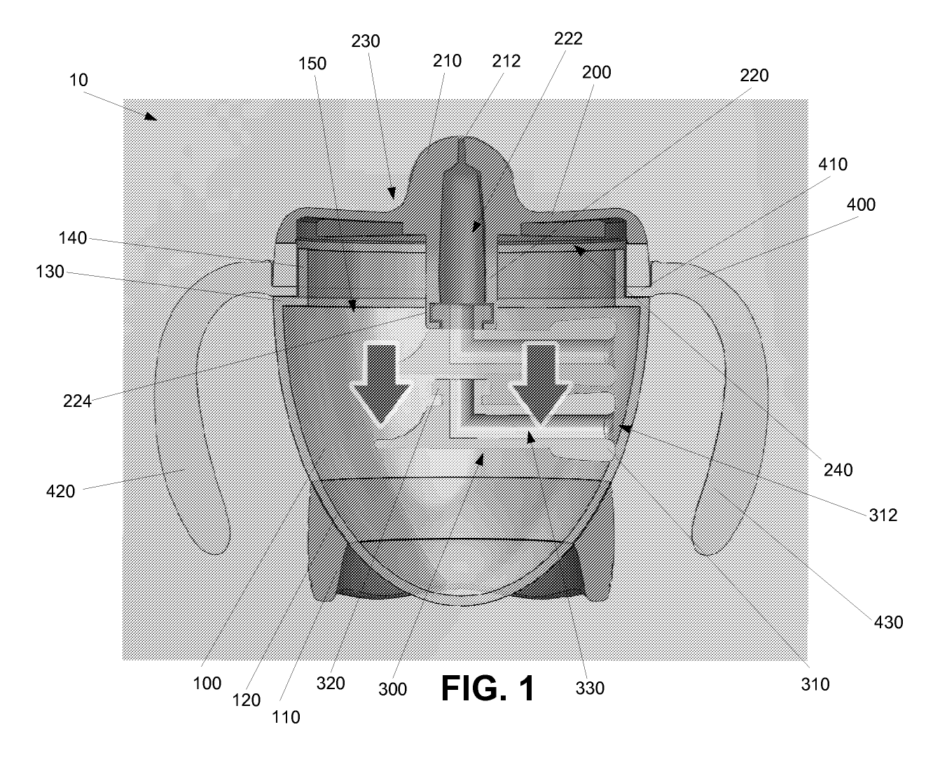

Referring to FIG. 1, a cross sectional view of an exemplary embodiment of the infant cup 10 in accordance with the present invention is illustrated. According to this embodiment, the infant cup 10 includes a container 100, a lid 200, an elbow straw 300, and a handle attachment 400. The container 100 is a rounded container with and opening 150 located at the top of the container 100. Furthermore, the container 100 contains a base 110 located at the bottom of the container 100 to provide support for the infant cup 10 to stand on a support surface. As illustrated, the container 100 contains a rounded bottom, which generates the need for the base 110. According to this embodiment, the base 110 is an extension from the sidewall 120 of the container 100. As illustrated, the base 110 is not configured to house fluid when fluid is placed within the container 100. In another embodiment, the container 100 may be shaped with a bottom that is configured to allow the container 100 to stand upon a support surface. Furthermore, at the top of the container 100, the sidewall 120 is formed into an edge 130 and a vertically extending rim 140. As illustrated, the edge 130 enables the handle attachment 400 to sit upon the edge 130 when attached to the container 100. Furthermore, the rim 140 enables the lid 200 to be removably coupled to the container 100. The lid 200 may attach to the container 100 via a snap fit, friction fit, threads, or other similar means. In this embodiment, the lid 200 contains internal threads (not shown) that mate with threads (not shown) on the rim 140 of the container 100 to enable the lid 200 to be screwed onto the container 100.

As stated previously, the handle attachment 400 rests upon the edge 130 of the container 100, which is formed from the sidewall 120 of the container 100. In this embodiment, the handle attachment 400 contains a ring 410, a first handle 420, and a second handle 430. The ring 410 is dimensioned to fit around the rim 140 of the container 100 and rest on top of the edge 130. Furthermore, extending outwardly from the ring 410 is the first handle 420 and the second handle 430. The two handles 420, 430 extend from the ring 410 at positions 180 degrees apart from one another. Therefore, a user of the infant cup 10 has handles 420, 430 positioned 180 degrees apart from one another around the infant cup 10. This configuration enables two-handed use by infants and children. In another embodiment, the infant cup 10 may have more or less then two handles, including no handles attached to the infant cup 10. Furthermore, in another embodiment, the handles 420, 430 may be repositionable with respect to one another.

The lid 200 of the infant cup 10 contains an exterior 230 and an interior 240. In this embodiment, the lid 200 is configured to be rounded and circular, similar to that of the container 100. This enables the lid 200 to be screwed onto the container 100 as described previously. Furthermore, disposed on the exterior 230 of the lid 200 is a spout 210. The spout 210 is disposed at a central location on the exterior of the lid 200. In other embodiments, the spout 210 may be disposed off center on the lid 200. The spout 210 is equipped with a fluid outlet 212, which is designed to deliver fluid from within the container 100 to a user. The interior 240 of the lid 200 contains an extension member 220 that extends vertically downward into the container 100 when the lid 200 is attached to the container 100. The extension member 220 further includes a channel 222 that delivers fluid from within the container 100 to the outlet 212 of the spout 210. At the end of the extension member 220 is a slot 224, which is configured to releasably receive the elbow straw 300 and allow the elbow straw 300 to rotate.

The elbow straw 300, as stated previously, is rotatably and releasably coupled to the lid 200. As illustrated, the elbow straw 300 contains a boss 320 on one end, and a tip 310 on the opposite end of the elbow straw 300. Furthermore, the elbow straw 300 comprises an L-shape, where a right angle is formed by the elbow straw 300 between the tip 310 and the boss 320. As illustrated, the boss 320 is sized and configured to be received by the slot 224 in the extension member 220 of the lid 200. The boss 320 is rounded to allow the straw 300 to rotate within the slot 224 of the extension member 220 of the lid 200. Furthermore, as illustrated, the tip 310 has a wider diameter than the remainder of the straw 300. In addition, the tip 310 of the elbow straw contains an inlet 312, configured to allow fluid to flow into the elbow straw 300. Moreover, a channel 330 runs from the inlet 312 through the boss 320, enabling the inlet 312 to be in fluid communication with the outlet 212 of the lid 200 when the elbow straw 300 is attached to the lid 200. The elbow straw 300, according to this embodiment, is constructed from a hard rigid material such as polypropylene. Further, as previously stated, the elbow straw 300 is removably coupled to the slot 224 of the extension member 220 of the lid 200 (shown in the ghosted representation at the middle of FIG. 1). As illustrated, the elbow straw 300 can be removed by a parent pulling downwardly on the elbow straw 300 (as illustrated by the arrows) to separate it from the extension member 220 of the lid. This enables easy cleaning of the lid 200 and the elbow straw 300 when needed.

In this embodiment, the tip 310 of the elbow straw 300 contains a weight that facilitates the tip 310 and the elbow straw 300 to point vertically downward with respect to the horizon during use of the infant cup 10. During use, the infant cup 10 is tilted to some degree sideways off of being vertical, the orientation illustrated in FIG. 1. When tilted sideways, gravity forces the elbow straw 300 to rotate within the slot 224 because gravity causes the weight in the tip 310 of the elbow straw 300 to be in its lowest position within the container 100. As the infant cup 10 is tilted, the fluid within the container 100 is repositioned within the container 100 due to gravity, causing the liquid and the tip 310 of the elbow straw 300 to be in contact with one another substantially all of the time. Thus, no matter what direction a child tips the infant cup 10, the tip 310 of the elbow straw 300 will rotate to be in contact with the fluid in the container 100. This allows a user to apply suction to the spout 210 and extract the fluid from within the container 100.

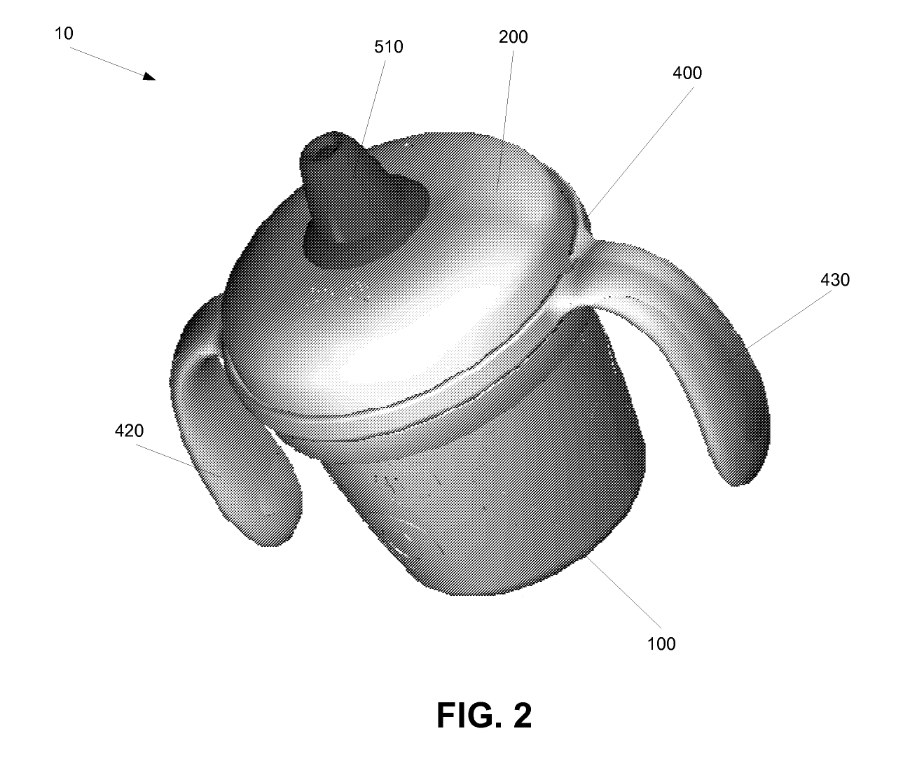

A second embodiment of the infant cup 10 is illustrated in FIGS. 2-5, 5a, 6, 6a, 6b, 7, 7a, and 8-11. Referring to FIG. 2, illustrated is a perspective view of the second embodiment of the infant cup 10. This embodiment of the infant cup 10 includes a container 100, a lid 200, and a spout 510. As illustrated, the lid 200 is coupled to the container 100. According to this embodiment, the lid 200 is removably attached to the container 100. Extending substantially upward from the center of the lid 200 is spout 510. Furthermore, an optional attachment to the container 100 is handle attachment 400. According to this embodiment, the handle attachment 400 includes a first handle 420 and a second handle 430. In other embodiments, the infant cup 10 may not include any handle attachment 400, or may include a handle attachment 400 with more or less than two handles 420, 430.

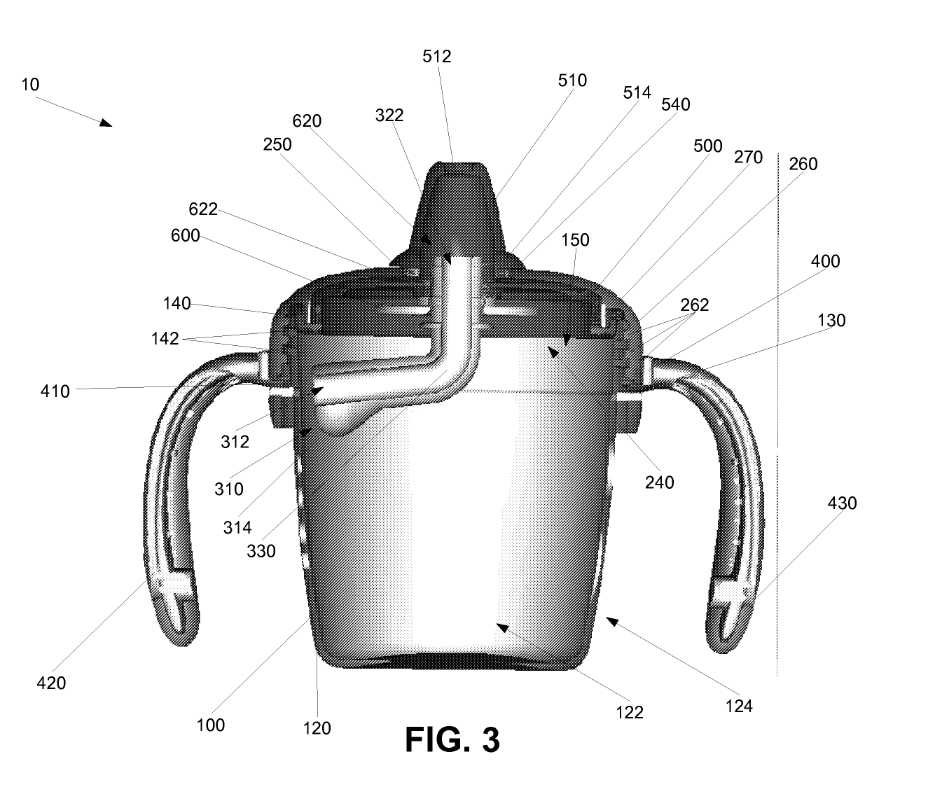

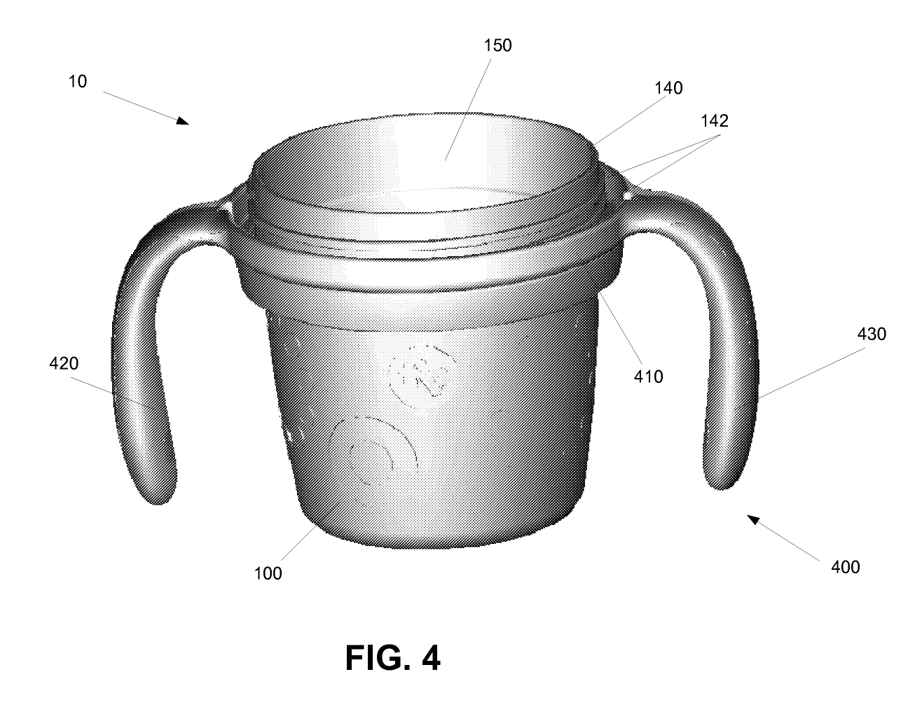

Turning to FIG. 3, illustrated is a cross-sectional view of the second embodiment of the infant cup 10. As previously stated, the infant cup 10 includes a container 100, a lid, a spout 510, and optionally, a handle attachment 400. As further illustrated by FIG. 3, the infant cup 10 also includes an elbow straw, an attachment collar 600, and insert 500. As best illustrated in FIGS. 3 and 4, the container 100 is substantially cylindrical in shape with a sidewall 120 that defines an exterior surface 124 and an interior surface 122. Because of the container's 100 shape and sidewall 120, the container 100 is configured to house a fluid placed within the interior 122 of the container 100. According to this embodiment, the sidewall 120 of the container 100 forms a substantially flat bottom that is configured to rest on a support surface. Moreover, proximate to the top of the container 100, the sidewall 120 is formed into an edge 130 and a vertically upstanding rim 140. The vertically upstanding rim 140 defines an opening 150 that provides access to the interior 122 of the container 100. As best illustrated in FIG. 3, the edge 130 enables the handle attachment 400 to rest upon the edge 130. Furthermore, the rim 140 enables the lid 200 to be removably coupled to the container 100. In this embodiment, rim 140 includes threads 142 that allow the lid 200 to be screwed onto the container 100.

Continuing with FIGS. 3 and 4, the handle attachment 400 includes a ring 410, a first handle 420 coupled to and extending from the ring 410, and a second handle 430 also coupled to and extending from the ring 410. In the embodiment illustrated, the first handle 420 is coupled to the ring 410 at a first position with the second handle 430 coupled to the ring 410 at a second position opposite the first position on the ring 410. In other words, the handles 420, 430 are spaced 180 degrees apart from one another on the ring 410. As stated previously regarding the first embodiment, the positioning of the handles 420, 430 enables two-handed use by infants and children. Furthermore, the ring 410 is dimensioned to fit around the rim 140 and threads 142 of the container 100 and rest upon the top of the edge 130. In addition, the ring 410 is configured to rotate about the container 100 while being supported by the edge 130. This enables the handles 420, 430 to be repositioned about the container 100.

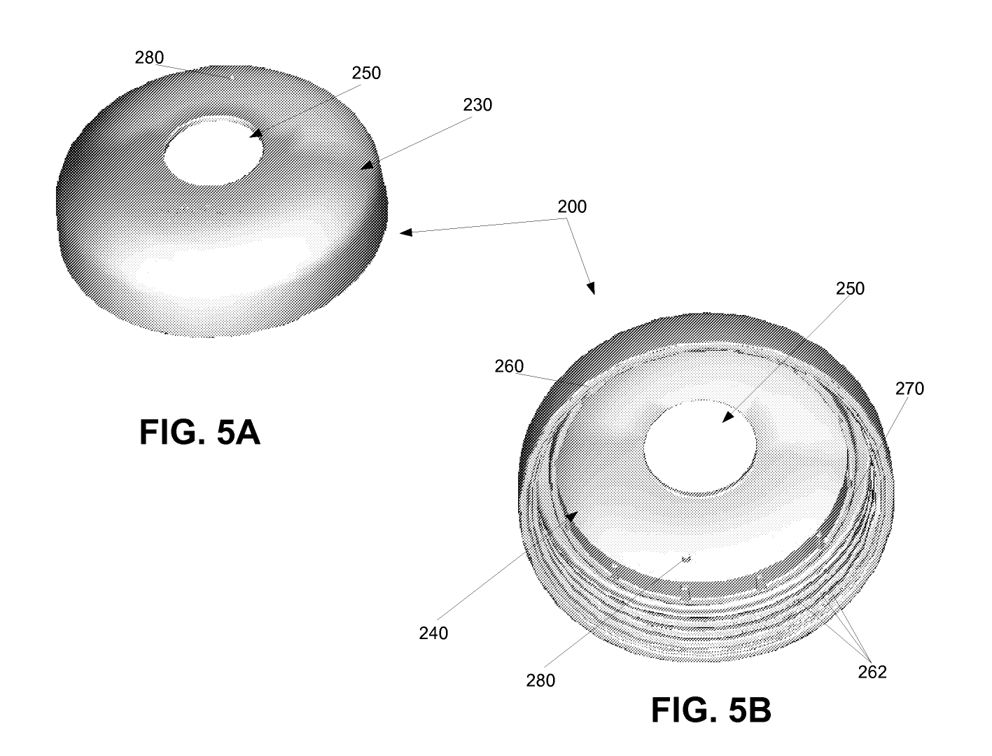

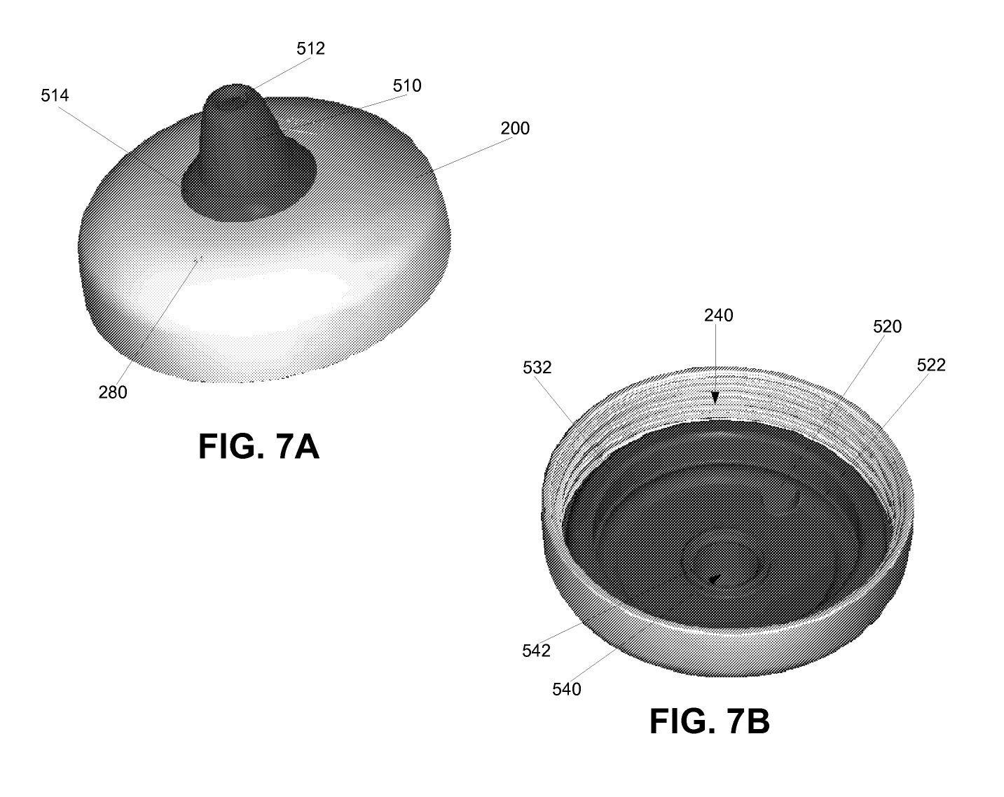

Turning to FIGS. 3, 5, and 5a, illustrated is the lid 200. The lid 200 of the infant cup 10 contains an exterior 230 and an interior 240. The lid 200 may be formed in a rounded and circular shape that enables the lid 200 to be screwed onto the container 100. In this embodiment, the lid 200 includes a centrally located opening 250, an offset orifice 280, and a skirt 260. As illustrated in FIGS. 3, 7, and 7a, the central opening 250 is configured to receive and support the spout 510. Furthermore, the offset orifice 280 may be located at any location on the lid 200, as it serves as an air inlet into the container 100 when the lid 200 is secured to the container 100 and suction is applied to the spout 510. The skirt 260 of the lid 200 extends downward and is configured to engage the rim 140 of the container 100. As shown in FIGS. 3 and 5a, the skirt 260 of the lid includes threads 262, and these threads 262 are configured to interact with the threads 142 of the rim 140 of the container 100 to removably secure the lid 200 to the container 100 by screwing the lid 200 onto the container 100. Furthermore, as illustrated in FIGS. 3 and 5a, extending downwardly from the interior 240 of the lid 200 is an extension member 270. The extension member 270 is a circular member that is positioned in the interior 240 of the lid 200 proximate to the skirt 260. The extension member 270 does not extend downwardly further than the skirt 260.

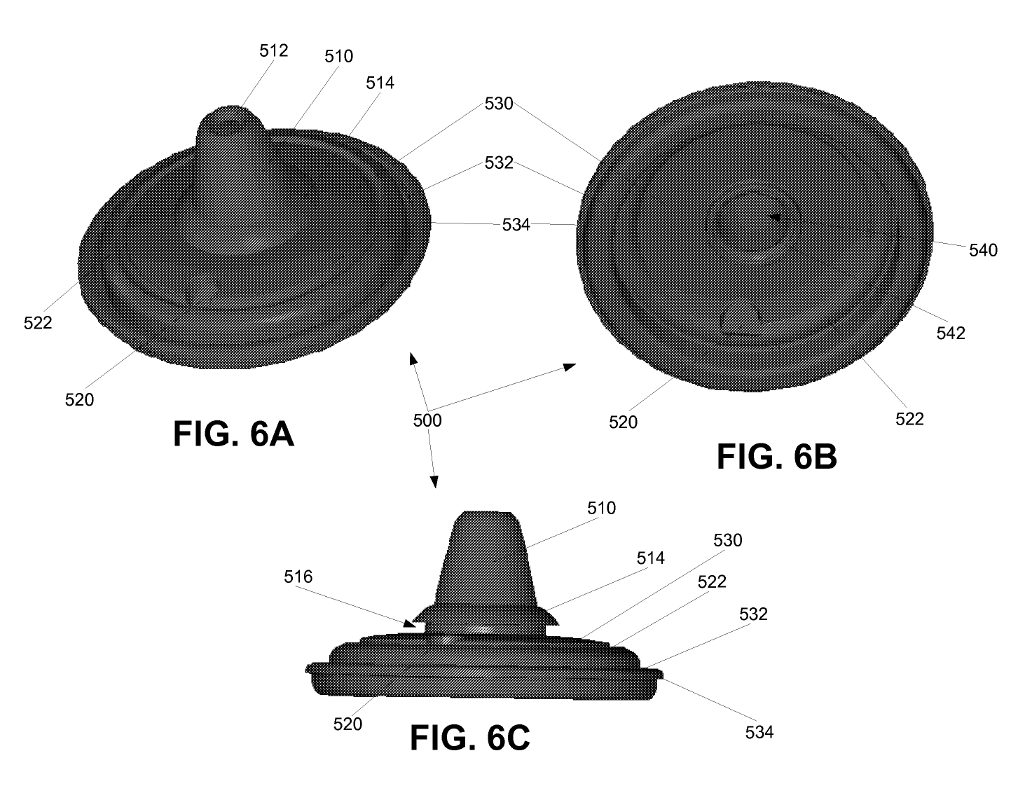

Referring to FIGS. 6, 6a, and 6b, illustrated is the insert 500 that is configured to be coupled to the lid 200. The insert 500 includes a circular base 530 with a centrally located spout 510 extending substantially upward from the base 530. In this embodiment, the insert 500 is uniformly constructed of a flexible and resilient material. In this embodiment, the spout 510 is formed in a substantially frusoconical shape. Located on the end of the spout 510 is a deformable valve member 512. The valve member 512 may include one or a plurality of slits that deform when pressure is applied to the spout 510. Deformation of the valve member 512 allows liquid to pass through the spout 510. Moreover, located near the base of the spout 510 is flange 514. As best seen in FIG. 6b, the flange 514 extends outwardly from the spout 510. Furthermore, the flange 514 is positioned on the spout 510 above the connection of the spout 510 to the base 530 creating a gap 516 between the flange 514 and the base 530.

Continuing with FIGS. 6, 6a, and 6b, the base 530 further includes an air port 520 that is offset from the spout 510 the same distance that the offset orifice 280 is offset from the central opening 250 on the lid 200. The base 530 also includes an air channel 522 that circumvents the spout 510. The air channel 522 is aligned with the air port 520 to at least partially intersect a portion of the air port 520. The base 530 further includes an outer channel 532 proximate to the outer edge 534 of the base 530.

As best illustrated by FIG. 6a, the underside of the insert 500 includes an aperture 540 that provide access into the spout 510. The edge of the aperture 540 includes an outcropping 542. Furthermore, according to this embodiment, as illustrated in FIG. 6a, the air port 520 forms a V-shape that extends downwardly from the base 530. The V-shape of the air port 520 may include a slit on the point of the V, the slit deforming into an opening when pressure is applied to the spout 510. The V-shape of the air port 520 enables the air port 520 to prevent liquid from flowing out of the air port 520 when the container 100 is tilted or tipped, causing liquid to rest against the insert 500 and the lid 200.

As illustrated in FIGS. 3, 7, and 7a, the insert 500 is configured to couple to the lid 200. The spout 510 and flange 514, are configured to extend through the opening 250 of the lid 200, and are positioned on the exterior 230 of the lid 200. Moreover, the base 530 of the insert 500 is positioned in the interior 240 of the lid 200. The flange 514 on the spout 510 is configured to have a diameter that is greater than the diameter of the opening 250 of the lid 200. The edge of the opening 250 on the lid 200 is positioned in the gap 516, between the flange 514 and the base 530. Furthermore, as illustrated, the outer channel 532 is configured to frictionally engage the extension member 270 (see FIG. 5a) in the interior 240 of the lid 200. The combination of the flange 514 extending beyond the diameter of the opening 250 on the exterior 230 of the lid 200 and the outer channel 532 frictionally engaging the extension member 270 on the interior 240 of the lid 200 couples the insert 500 into the lid 200.

In addition, as stated previously, the air port 520 is positioned at a location on the base 530 of the insert 500 the same distance from the center of the insert 500 as the distance from the center of the lid 200 to the offset orifice 280. Therefore, when the insert 500 is coupled to the lid 200, the air port 520 is aligned with the offset orifice 280, providing fluid communication between the air port 520 and the offset orifice 280. Positioning the insert 500 perfectly on the lid 200 so that the air port 520 and the offset orifice 280 are aligned may be difficult. Furthermore, the insert 500 may rotate when coupled to the lid 200. However, the air channel 522 circulates around the entire base 530 of the insert 500 at a distance from the center of the insert 500 that is equal to the distance the offset orifice 280 is from the center of the lid 200. Therefore, the offset orifice 280 is aligned with some portion of the air channel 522 in any position the insert 500 may be positioned on the lid 200. Furthermore, because the air channel 522 intersects the air port 520, the offset orifice 280 will always be in fluid communication with the air port 520 when the insert 500 is coupled to the lid 200.

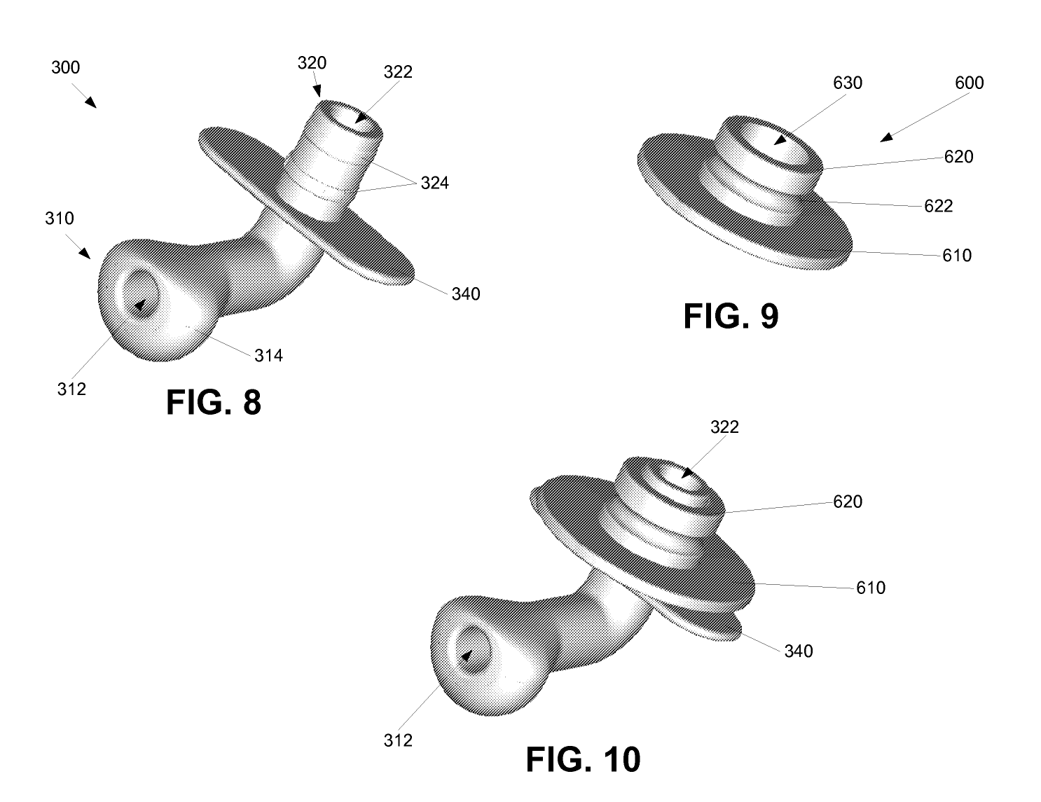

Referring to FIGS. 8, 9, and 10, illustrated is the elbow straw 300 and the attachment collar 600. As illustrated, the elbow straw 300 includes a first end 310 and a second end 320, and forms an L-shaped with a right angle between the first end 310 and the second end 320. According to this embodiment, the first end 310 of the elbow straw 300 is wider than the remainder of the elbow straw 310. As best illustrated in FIGS. 3 and 8, the bottom and sides of the first end 310 extend out from the straw 300, creating a weighted portion 314. Furthermore, at the first end 310 of the straw 300 is an inlet 312, configured to allow fluid to flow into the elbow straw 300. Moreover, the second end 320 of the straw 300 includes an outlet 322, configured to allow fluid to flow out of the elbow straw 300. As best illustrated in FIG. 3, a channel 330 connects the inlet 312 to the outlet 322, enabling fluid to flow from the inlet 312 to the outlet 322 through the elbow straw 300. The elbow straw 300 further includes a set of bosses 324 located proximate to the second end 320, the bosses 324 extending outwardly from the elbow straw 300. The elbow straw 300 further includes an extension member 340 that extends outwardly from the elbow straw 300 at a location between the right angle bend and the second end 320.

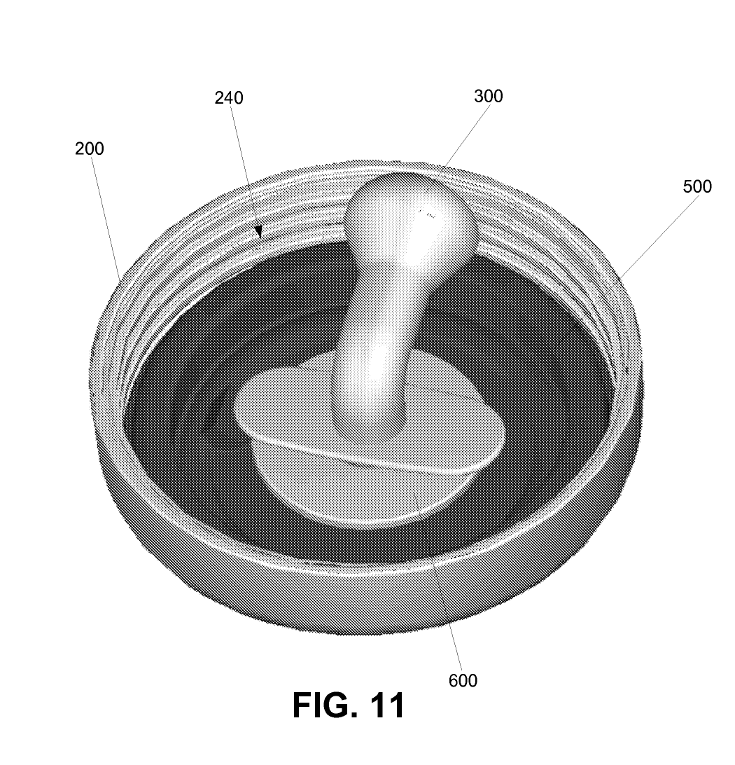

As best illustrated in FIG. 9, illustrated is a perspective view of the attachment collar 600. The collar 600 includes a circular flange 610, a cylinder 620 extending upwardly from the flange 610, and a channel 630 that extends through the cylinder 620 and the flange 610. The channel 630 is sized to accept the insertion of the second end 320 of the elbow straw 300 into the channel 630. When the attachment collar 600 is attached to the elbow straw 300, as illustrated in FIG. 10, the second end 320 of the straw 300 extends upwardly through the collar 600 so the flange 610 of the collar 600 is positioned adjacent to the extension member 340 of the straw 300. As illustrated in FIG. 10, the extension member 340 extends from the elbow straw 300 a distance farther than the diameter of the flange 610 when the collar 600 is attached to the straw 300. Furthermore, the straw 300 is configured to rotate or spin within the collar 600. The bosses 324 enable the straw 300 to be coupled to the collar 600, but still enable the elbow straw 300 to rotate within the collar 600. In addition, as illustrated in FIG. 9, the collar 600 includes depression 622 in the cylinder 620. The depression 622 is configured to attach the collar 600 to the insert 500.

Referring to FIG. 11, illustrated is the interior 240 of the lid 200 with the insert 500 coupled to the lid 200, attachment collar 600 coupled to the insert 500, and the elbow straw 300 rotatably coupled to the collar 600. As previously described and shown in FIGS. 7 and 7a, the insert 500 is configured to be coupled to the lid 300 with the spout 510 extending from the exterior 230 of the lid 200 and the aperture 540 with the outcropping 542 being on the interior 240 of the lid 200. As illustrated in FIGS. 3 and 11, the collar 600 is coupled to the aperture 540 of the insert 500. Best illustrated in FIG. 3, the depression 622 is configured to engage the outcropping 542 of the aperture 540 of the insert 500. Furthermore, as illustrated in FIG. 3, when the elbow straw 300 is rotatably coupled to the collar 600 and the collar 600 is attached to the insert 500, the inlet 312 of the elbow straw 300 is in fluid communication with the valve member 512 of the spout 510. Fluid is configured to flow into the inlet 312 of the elbow straw 300, travel through the channel 330 to the outlet 322 of the straw 300 into the spout 510 and to the valve member 512.

During use, the weight 314 of the first end 310 of the elbow straw 300 facilitates the first end 310 and the elbow straw 300 to point vertically downward with respect to the horizon during use of the infant cup 10. During use, the infant cup 10 is tilted to some degree sideways off the vertical orientation illustrated in FIGS. 1 and 3. When tilted, gravitational forces cause the elbow straw 300 to rotate within the attachment collar 600 because gravity causes the weight 314 in the first end 310 of the elbow straw 300 to be in its lowest position within the container 100. As the infant cup 10 is tilted, the fluid within the container 100 is also repositioned within the container 100 due to gravity, causing the liquid and the first end 310 of the elbow straw 300 to be in contact with one another. Thus, no matter what direction a child tips the infant cup 10, the first end 310 of the elbow straw 300 will rotate to be in contact with the fluid in the container 100. This allows a user to apply suction to the spout 510 and extract the fluid from within the container 100. In other embodiments, the elbow straw 300 may be more flexible, enabling the first end 310 of the straw 300 to move throughout the container 100 rather than just rotate within the collar 600.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. An infant cup comprising:
a container comprising an opening;
a lid removably coupled to the container, the lid comprising an exterior, an interior and an outlet disposed on the exterior of the lid; and
a straw rotatably coupled to the interior of the lid and in fluid communication with the outlet of the lid, the straw configured to rotate within the container.

2. The infant cup as set forth in claim 1, wherein the outlet is centrally located on the exterior of the lid.

3. The infant cup as set forth in claim 1, wherein the lid further comprises an air vent.

4. The infant cup as set forth in claim 1, further comprising at least one handle rotatably coupled to the container.

5. The infant cup as set forth in claim 1, wherein the outlet comprises a valve member configured to deform when pressure is applied to the outlet.

6. An infant cup comprising:
a container comprising an opening;
a lid removably coupled to the container, the lid comprising an exterior, an interior and an aperture;
an insert comprising an outlet, the insert removably coupled to the interior of the lid with the outlet of the insert extending through the aperture; and
a straw member rotatably coupled to the insert, the straw being in fluid communication with the outlet of the insert and configured to rotate within the container.

7. The infant cup as set forth in claim 6, wherein the aperture is centrally located on the lid.

8. The infant cup as set forth in claim 6, wherein the lid further comprises an air vent.

9. The infant cup as set forth in claim 8, wherein the insert further comprises:
an air valve, the air valve being in fluid communication with the air vent of the lid when the insert is coupled to the interior of the lid.

10. The infant cup as set forth in claim 6, wherein the insert is constructed of a flexible and resilient material.

11. The infant cup as set forth in claim 6, wherein the outlet of the insert comprises a valve member configured to deform when pressure is applied to the outlet.

12. The infant cup as set forth in claim 6, further comprising at least one handle rotatably coupled to the container.

13. The infant cup as set forth in claim 6, wherein the straw member comprises:
a collar attachment being coupled to the insert; and
a straw with a first end and a second end, the second end of the straw being rotatably and removeably coupled to the collar attachment.

14. The infant cup as set forth in claim 13, wherein the first end of the straw includes a weighted portion.

15. An infant cup comprising:
a container comprising an opening and at least one sidewall;
a lid removably coupled to the container, the lid comprising an exterior, an interior, and an outlet; and
a straw with a first end and a second end, the second end being coupled to the lid and configured to be in fluid communication with the outlet, the first end of the straw being rotationally repositionable to maintain a constant rotational distance to the at least one sidewall of the container.

16. The infant cup as set forth in claim 15, wherein the outlet is centrally located on the lid.

17. The infant cup as set forth in claim 15, wherein the first end of the straw includes a weighted portion.

18. The infant cup as set forth in claim 15, wherein the lid further comprises an air vent.

19. The infant cup as set forth in claim 15, further comprising at least one handle rotatably coupled to the container.

20. The infant cup as set forth in claim 15, wherein the straw further comprises a valve member configured to deform when pressure is applied to the outlet.
